(19) United States
(12) Patent Application Publication
(10) Pub. No.: US 2023/0249278 A1
(43) Pub. Date: Aug. 10, 2023

(54) SPOT WELDING METHOD AND SPOT WELDING APPARATUS

(71) Applicant: SUBARU CORPORATION, Tokyo (JP)

(72) Inventor: Masahiro YOKOI, Tokyo (JP)

(21) Appl. No.: 18/090,889

(22) Filed: Dec. 29, 2022

(30) Foreign Application Priority Data
Feb. 10, 2022 (JP) 2022-019558

(51) Int. Cl. B23K 11/11; B23K 11/34; B21D 28/02

(52) U.S. Cl. CPC B23K 11/115; B23K 11/34; B21D 28/02

(57) ABSTRACT

A spot welding method for welding a first panel and a second panel by applying a current between a pair of electrodes in pairs in a state in which the first panel and the second panel overlap one another and are held by the electrodes includes: forming a protrusion on a surface facing the second panel, at a welding-target part of the first panel; forming a recess on a surface facing the protrusion, at a welding-target part of the second panel, such that the recess has a depth that allows a top of the protrusion to come into contact with a bottom of the recess; and holding the welding-target part of the first panel and the welding-target part of the second panel between the electrodes, in a state in which the protrusion is inserted in the recess and applying the current between the electrodes.

### CROSS-REFERENCE TO RELATED APPLICATIONS

The present application claims priority from Japanese Patent Application No. 2022-019558 filed on Feb. 10, 2022, the entire contents of which are hereby incorporated by reference.

### BACKGROUND

The disclosure relates to a spot welding method and a spot welding apparatus for welding two panels, which are held between a pair of electrodes, by applying a current between the electrodes.

Known methods for welding metal panels include resistance welding that involves applying a large current to overlapping panels and welding the panels together by the generated heat.

In spot welding, which is a kind of resistance welding, overlapping panels are held between a pair of electrodes and are then pressurized to be in contact with each other at welding-target parts, whereby electric conductivity is obtained. If they are not sufficiently in contact with each other, welding failure can occur. In particular, in a case in which a viscous material, such as weld bond, is applied between two panels, the applied viscous material may enter between the welding-target parts from the vicinities thereof at the time the two panels are pressed to each other and may inhibit the application of current.

In such a condition that the panels are not sufficiently in contact with each other at the welding-target parts, current may flow through a part other than the welding-target parts of the panels to generate a branch path, which may cause an undesirable phenomenon such as explosion.

Japanese Unexamined Patent Application Publication No. H5-285669 discloses projection welding as a method for welding two panels while obtaining electric conductivity. This projection welding involves forming a projection on a first panel and applying a current between the first panel and a flat second panel to which the first panel is pressed.

### SUMMARY

An aspect of the disclosure provides a spot welding method for welding a first panel and a second panel by applying a current between electrodes in pairs in a state in which the first panel and the second panel overlap one another and are held by the electrodes. The method includes: forming a protrusion on a surface facing the second panel, at a welding-target part of the first panel; forming a recess on a surface facing the protrusion, at a welding-target part of the second panel, such that the recess has a depth that allows a top of the protrusion to come into contact with a bottom of the recess; and holding the welding-target part of the first panel and the welding-target part of the second panel between the electrodes, in a state in which the protrusion is inserted in the recess and applying the current between the electrodes.

An aspect of the disclosure provides a spot welding apparatus. The spot welding apparatus includes a fixed electrode and a movable electrode. The fixed electrode is fixed to an apparatus body. The movable electrode is configured to be brought close to and away from the fixed electrode. The spot welding apparatus is configured to weld a first panel and a second panel by applying a current between the fixed electrode and the movable electrode in a state in which the first panel and the second panel overlap one another and are held by the fixed electrode and the movable electrode. The spot welding apparatus further includes a processing mechanism. The processing mechanism is configured to move to a processing position at which the processing mechanism presses the first panel and the second panel and to return from the processing position to a non-processing position. The processing mechanism includes a tapered bar-shaped member and a die. The tapered bar-shaped member is provided in a vicinity of the movable electrode. The bar-shaped member is configured to be moved, by a driver configured to move the movable electrode, in a movement direction of the movable electrode at the processing position. The die is provided in a vicinity of the fixed electrode. The die has a notch corresponding to a shape of a tip of the bar-shaped member. The die is configured to allow the first panel and the second panel to be placed on the die at the processing position.

### BRIEF DESCRIPTION OF THE DRAWINGS

The accompanying drawings are included to provide a further understanding of the disclosure and are incorporated in and constitute a part of this specification. The drawings illustrate an example embodiment and, together with the specification, serve to describe the principles of the disclosure.

FIG. 1 is a side view schematically illustrating a main section of a spot welding apparatus of an embodiment of the disclosure.

FIG. 2 is a side view illustrating movement of the spot welding apparatus.

FIG. 3A is a sectional view illustrating a process of forming a protrusion and a recess.

FIG. 3B is a sectional view illustrating the process of forming the protrusion and the recess.

FIG. 4 is a side view illustrating movement of the spot welding apparatus.

FIG. 5 is a flowchart illustrating a procedure of a method of joining a first and a second panel.

FIG. 6 is a sectional view of the first and the second panel.

FIG. 7A is a sectional view illustrating a process of welding the first and the second panel.

FIG. 7B is a sectional view illustrating the process of welding the first and the second panel.

FIG. 7C is a sectional view illustrating the process of welding the first and the second panel.

FIG. 8 is a sectional view of the first and the second panel being in contact with each other at the time of welding.

### DETAILED DESCRIPTION

In projection, welding, a projection that is formed on a first panel is brought into contact with a surface of a second panel, and current is then made to flow from the projection to the second panel. Unfortunately, the panels have a set gap therebetween, which is generated by the height of the projection when the panels are set, and they are welded in the condition of having the gap, resulting in a reduction in product accuracy.

It is desirable to provide a spot welding method and a spot welding apparatus, each which enables preventing generation of a gap between panels so as to obtain electric conductivity at welding-target parts and thereby reducing welding failure.

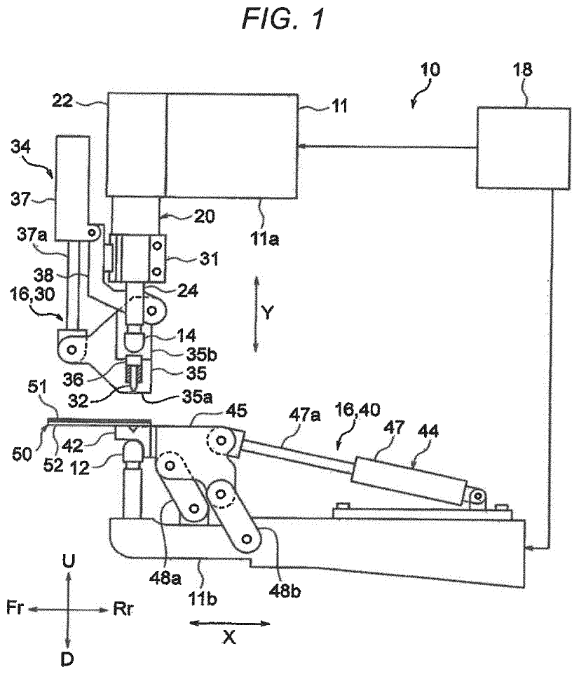

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. FIG. 1 is a side view schematically illustrating a main section of a spot welding apparatus 10 of the embodiment of the disclosure. The spot welding apparatus 10 is used, for example, in a process of manufacturing vehicles such as automobiles (e.g., in joining panels that constitute a vehicle body). The spot welding apparatus 10 is configured to weld metal panels 51 and 52 together by applying a current between a pair of electrodes that hold the panels 51 and 52, which are at least partially overlapped each other.

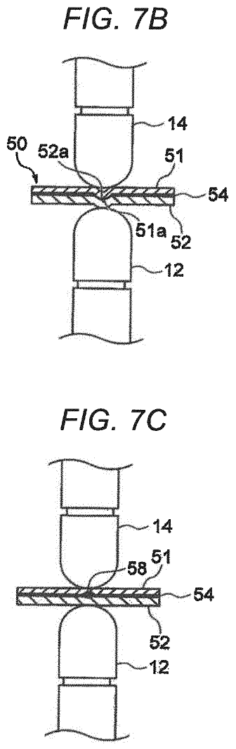

In this embodiment, the metal first panel 51 and the metal second panel 52 are described as examples of elements of a work 50 to be subjected to spot welding. In the work 50 to be subjected to spot welding, an adhesive 54, which is a viscous material, is applied between the panels 51 and 52, as illustrated in FIG. 7A. This embodiment uses a thermosetting material, such as weld bond, as the adhesive 54. The panels 51 and 52 may have the same thickness or may have different thicknesses, and in this embodiment, the second panel 52 is thicker than the first panel 51.

As illustrated in FIG. 1, the spot welding apparatus 10 includes an apparatus body 11, a fixed electrode 12 and a movable electrode 14 that are held by the apparatus body 11, a drive mechanism 20 for moving the movable electrode 14, a processing mechanism 16 for pressing the work 50, and a control device (controller) 18. FIG. 1 illustrates a section in which the fixed electrode 12, the movable electrode 14, and the processing mechanism 16 are mounted to the apparatus body 11. The control device 18 is electrically coupled to a power supply unit (not illustrated) for the electrodes 12 and 14, the drive mechanism 20, and the processing mechanism 16.

In this embodiment, the movable electrode 14 can be uniaxially moved in a Y direction by the drive mechanism 20. The Y direction corresponds to an up-down direction in FIG. 1. For the spot welding apparatus 10 illustrated in FIG. 1, the reference signs U and D respectively represent an upper direction and a downward direction, whereas the reference signs Fr and Rr respectively represent a front direction and a rear direction. An X direction that is orthogonal to the Y direction corresponds to the front-rear direction in FIG. 1. In addition, in FIG. 1, a Z direction that is orthogonal to the Y direction and the X direction corresponds to a depth direction of the paper surface of FIG. 1. In the following descriptions, the depth side of the paper surface in FIG. 1 is referred to as a “left side”, and the front side of the paper surface in FIG. 1 is referred to as a “right side”, in the Z direction.

The fixed electrode 12 is fixed to the apparatus body 11, and in this embodiment, it is fixed at an end of a support bracket 11b that is on the downward side of the apparatus body 11. The movable electrode 14 is opposed to the fixed electrode 12 so that its center axis will be coaxial with the center axis of the fixed electrode 12, and it is configured to be brought close to or away from the fixed electrode 12 by a driving force of the drive mechanism 20.

The drive mechanism 20 includes an actuator 22 and a rod 24 that is coupled to the actuator 22 while extending in the Y direction. The actuator 22 is fixed to a support bracket 11a that is on the upper side of the apparatus body 11. The actuator 22 can be composed of, for example, an air cylinder, a servo cylinder, or a servo motor. The rod 24 axially advances or retracts in the Y direction by a driving force of the actuator 22.

The movable electrode 14 is provided at a top end of the rod 24 of the drive mechanism 20. The movable electrode 14 moves between a retracted position and a pressure welding position. The movable electrode 14 is moved in the upper direction in FIG. 1 to the retracted position by the action of the drive mechanism 20. The movable electrode 14 is also moved in the downward direction in FIG. 1 to the pressure welding position, at which it comes into contact with the surface of the first panel 51 of the set work 50 and applies a pressure to the first panel 51. The fixed electrode 12 and the movable electrode 14 are coupled to the power supply unit, which is not illustrated. This power supply unit is electrically coupled to the control device 18 and applies a current between the electrodes 12 and 14 upon receiving a signal from the control device 18.

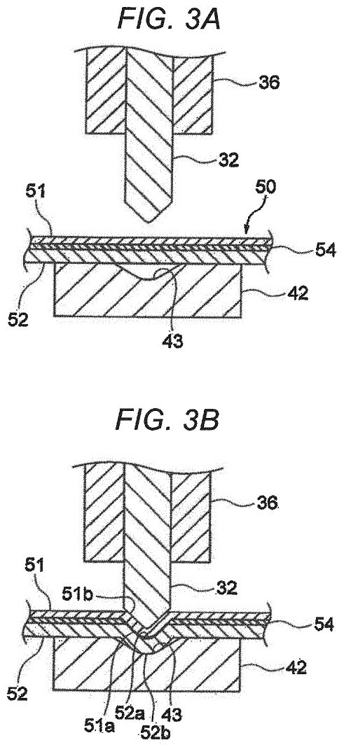

The processing mechanism 16 is configured to press the work 50. With this processing mechanism 16, a protrusion 51a is formed on a surface facing the second panel 52 of the first panel 51, whereas a recess 52a is formed on a surface facing the protrusion 51a of the second panel 52, as illustrated in FIGS. 3A and 3B. The processing mechanism 16 includes a male die part 30 and a female die part 40. The male die part 30 is mounted to the support bracket 11a, which is on the upper side of the apparatus body 11. The female die part 40 is mounted to the support bracket 11b, which is on the downward side of the apparatus body 11. The male die part 30 has a tapered bar-shaped member as a processing tool. This embodiment uses a punch 32 as an example of this bar-shaped member. The male die part 30 also has a male die movement mechanism 34 for moving the punch 32. The female die part 40 has a die 42, which constitutes a female die, and a female die movement mechanism 44 for moving the die 42. In the following descriptions, the male die part 30, the male die movement mechanism 34, the female die part 40, and the female die movement mechanism 44 are respectively called a “punch part 30”, a “punch movement mechanism 34”, a “die part 40”, and a “die movement mechanism 44”.

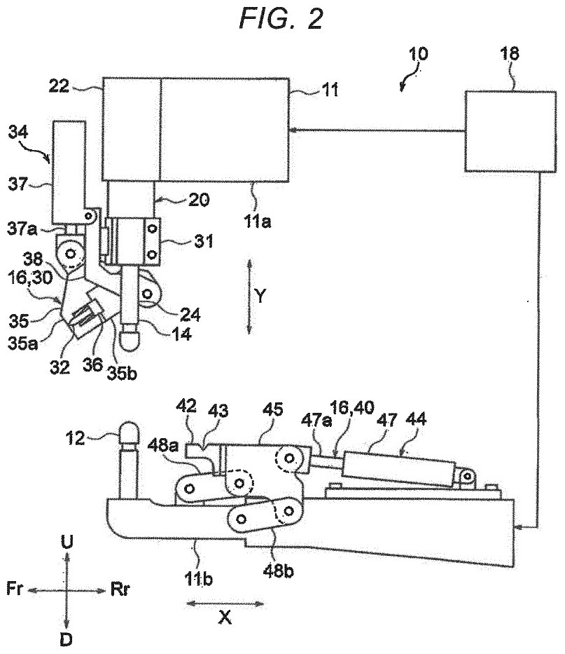

The punch part 30 is mounted to the upper-side support bracket 11a so as to be provided in the vicinity of the movable electrode 14. The punch 32 is configured to move to a processing position, as illustrated in FIG. 1, and to a non-processing position, as illustrated in FIG. 2, by the punch movement mechanism 34. The punch 32 processes the work 50 at the processing position. The punch 32 returns from the processing position to the non-processing position. The punch 32 is disposed so that its axis will be coaxial with the movable electrode 14 while being disposed on a downward side (that is, a fixed electrode 12 side) of the movable electrode 14, at the processing position. The punch 32 is off the axis of the movable electrode 14 and is positioned forward of the movable electrode 14 in this embodiment, at the non-processing position.

In this embodiment, the punch movement mechanism 34 is attached to the rod 24 of the drive mechanism 20 by using a fixture 31. The punch movement mechanism 34 includes a plate 35 on which the punch 32 is attached, and a punch actuator 37 and a support arm 38 that are coupled to the plate 35. A proximal end of the support arm 38 is fixed to the fixture 31, and the support arm 38 extends downward from the proximal end. In this embodiment, the support arm 38 is formed into a bent shape, and a distal end of the support arm 38 is disposed on the left side in the Z direction (depth side of the paper surface of FIG. 1) so as to be off the axis of the rod 24. The punch actuator 37 is fixed to the fixture 31 via the support arm 38 and has a drive rod 37a that is configured to extend and contract in the Y direction.

The plate 35 is formed into an approximately triangle shape. The plate 35 is rotatably coupled to the distal end of the support arm 38 at a first corner of the plate 35. The plate 35 is also rotatably coupled to a distal end of the drive rod 37a at a second corner of the plate 35. A third corner of the plate 35 has a flat pressing surface 35a, which faces the die 42 at the processing position illustrated in FIG. 1.

The punch 32 is attached to the plate 35 via a linearly movable member 35b. The linearly movable member 35b linearly moves the punch 32 in the axial direction. This embodiment uses a linear guide as an example of the linearly movable member 35b. A base part of the punch 32 is held by a holder 36 that is linearly movably attached to the linearly movable member 35b. The linearly movable member 35b is attached to the plate 35 in such a manner that the direction of the linear movement corresponds to the Y direction at the processing position illustrated in FIG. 1. The holder 36 is on the axis of the movable electrode 14 and is disposed under the movable electrode 14, and the punch 32 extends downward from the holder 36, at the processing position.

The punch 32 comes to the processing position illustrated in FIG. 1 in response to extension of the drive rod 37a of the punch actuator 37, and it comes to the non-processing position illustrated in FIG. 2 in response to contraction of the drive rod 37a of the punch actuator 37. The punch part 30 is positioned above the movable electrode 14 at the non--processing position.

The die part 40 is mounted to the downward-side support bracket 11b so as to be provided in the vicinity of the fixed electrode 12. The die 42 can be moved between a processing position illustrated in FIG. 1 and a non-processing position illustrated in FIG. 2 by the die movement mechanism 44. The die 42 is disposed on the axis of the fixed electrode 12 over the fixed electrode 12, at the processing position. The fixed electrode 12 supports the die 42 from below, at the processing position. The die 42 is off the axis of the fixed electrode 12 and is positioned rearward of the fixed electrode 12 in this embodiment, at the non-processing position.

In this embodiment, the die movement mechanism 44 includes a holding member 45 for holding the die 42, a die actuator 47 for applying power to the holding member 45, and a first link 48a and a second link 48b that supports the holding member 45 in a movable manner relative to the support bracket 11b. The die actuator 47 is formed into a tubular shape, and it is rotatably coupled to the support bracket 11b at a proximal end and has an extendable drive rod 47a on a distal end side. The first link 48a and the second link 48b are rotatably coupled to the support bracket 11b at proximal ends and are rotatably coupled to the holding member 45 at distal ends.

The die 42 comes to the processing position illustrated in FIG. 1 in response to extension of the drive rod 47a of the die actuator 47, and it comes to the non-processing position illustrated in FIG. 2 in response to contraction of the drive rod 47a of the die actuator 47. The die part 40 is positioned below the fixed electrode 12 at the non-processing position.

As illustrated in FIGS. 1 and 2, the die 42 has a notch 43 on a surface, which faces the punch 32 at the time of processing, and the notch 43 has a shape corresponding to the shape of the tip of the punch 32. As illustrated in FIG. 3A, the tip of the punch 32 is formed into an approximately conical shape. The tip of the punch 32 is rounded. The notch 43 of the die 42 is formed into an approximately conical shape so as to correspond to the shape of the tip of the punch 32. In this embodiment, the notch 43 is formed so that a central angle of the conical shape will be greater than that of the conical shape of the punch 32. It is noted that the shape of the tip of the punch 32 and the shape of the notch 43 are not limited to conical shapes and may be, for example, approximately hemispherical shapes.

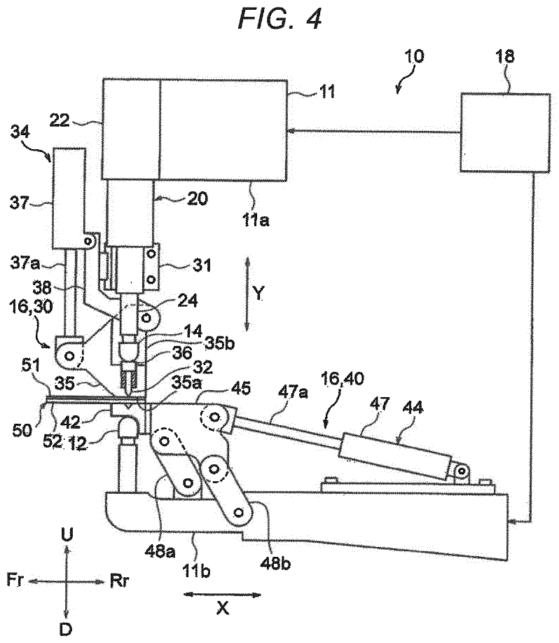

The processing mechanism 16 is configured to move the punch 32 in the downward side in the Y direction, which is the movement direction of the movable electrode 14, by using the drive mechanism 20 for moving the movable electrode 14, in the condition in which the punch part 30 and the die part 40 are in the processing positions illustrated in FIG. 1. For example, in response to the movable electrode 14 being moved downward by the drive mechanism 20, at the processing position in FIG. 1, the movable electrode 14 comes into contact with the holder 36, as illustrated in FIG. 4. As described above, the holder 36 and the punch 32 can be moved in the Y direction relative to the plate 35 by the linearly movable member 35b. Thus, in response to the movable electrode 14 being moved further downward by the drive mechanism 20 while being in contact with the holder 36, the holder 36 and the punch 32 are pushed by the movable electrode 14 and move downward. Thus, the punch 32 is applied with pressure and is pushed toward the notch 43 of the die 42.

The control device 18 is composed of an information processor such as a CPU, a storage such as a RAM or a ROM, an input/output interface, etc. The control device 18 controls movement of the punch 32, the die 42, and the movable electrode 14, pressure of each of these components to the work 50, a value of welding current supplied to each of the electrodes 12 and 14, and so on, based on programs stored in the storage (e.g., positions of the punch 32 and the die 42 at each timing, the Y direction position and pressure of the punch 32 at the time of processing, the direction position and pressure of the movable electrode 14 at each timing, and current applied to the fixed electrode 12 and the movable electrode 14 at each timing).

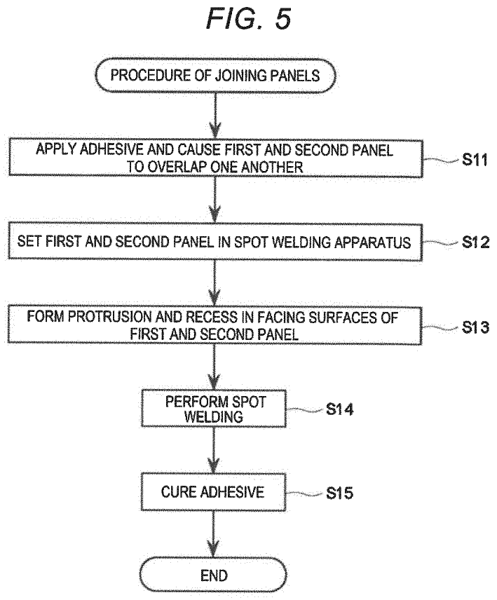

Next, a spot welding method using the spot welding apparatus 10 will be described. The first panel 51 and the second panel 52 of this embodiment are joined with the adhesive 54 and by spot welding, in accordance with the following processes. That is, the panels 51 and 52 that are applied with the adhesive 54 are caused to overlap one another, and a protrusion and a recess are formed at each of the welding-target parts of the panels 51 and 52 by pressing. Then, the welding-target parts are spot-welded, and the adhesive 54 is cured. The following describes a procedure of joining the first panel 51 and the second panel 52, in accordance with the flowchart illustrated in FIG. 5.

First, the adhesive 54 is applied to the first panel 51 and/or the second panel 52, and the first panel 51 and the second panel 52 are caused to overlap on one another in the state in which the adhesive 54 is applied between the panels 51 and 52 (step S11).

Next, a work 50 in which the first panel 51 and the second panel 52 overlap on one another is set to the spot welding apparatus 10 (step S12). The work 50 is set to the spot welding apparatus 10 in the state in which the adhesive 54 is still not cured (the adhesive 54 is in an uncured state). At this stage, the spot welding apparatus 10 is in the state in which the processing mechanism 16 is set at the processing position, as illustrated in FIG. 1. The work 50 is set in such a manner that the second panel 52 is disposed on the die 42 side and that the welding-target parts to be subjected to spot welding of the first panel 51 and the second panel 52 are disposed above the notch 43 of the die 42.

Thereafter, the work 50 is pressed by using the processing mechanism 16, whereby the protrusion 51a and the recess 52a are respectively formed on the facing surfaces of the first panel 51 and the second panel 52 (step S13). The pressing is performed in the state in which the adhesive 54 is still not cured. In pressing, the rod 24 is extended by operating the drive mechanism 20, as illustrated in FIG. 4. Thus, the pressing surface 35a of the plate 35 comes into contact with the upper surface of the first panel 51 and presses the work 50 to the die 42. Then, the rod 24 is further extended, whereby the movable electrode 14 comes into contact with the holder 36, and the holder 36 and the punch 32 are pushed downward of the plate 35 by a pressing force applied from the movable electrode 14. This applies a pressing force of the punch 32 to the work 50 in the direction from the first panel 51 to the die 42, as illustrated in FIGS. 3A and 3B. This pressing forms a protrusion 51a that protrudes to the second panel 52, on the first panel 51, and it also forms a recess 52a that is recessed on the first panel 51 side, on the second panel 52. In this process, the adhesive 54 in the uncured state is pushed aside to the vicinities of the protrusion 51a and the recess 52a.

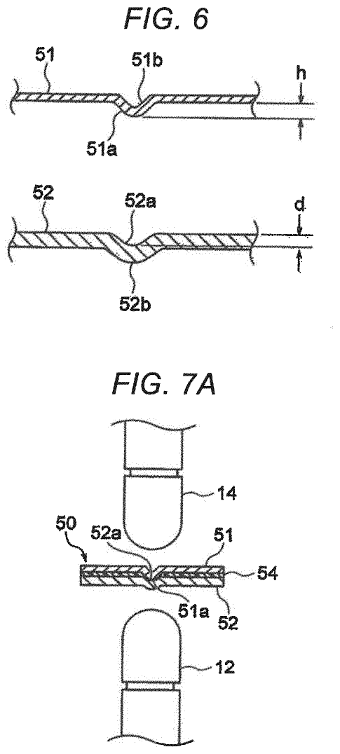

In this embodiment, the thickness of the second panel 52 is larger than that of the first panel 51, and a section modulus of the second panel 52 is greater than that of the first panel 51. For this reason, the amount of spring back at the processed part of the second panel 52 is greater than that at the processed part of the first panel 51. Thus, as illustrated in FIG. 6, the height (height from the surface facing the second panel 52) h of the protrusion 51a of the first panel 51 is greater than the depth d of the recess 52a of the second panel 52.

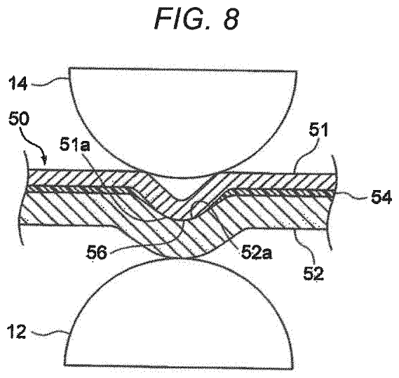

Next, the processing mechanism 16 is returned to the non-processing position, and spot welding is performed on the welding-target parts of the work 50 in the state in which the adhesive 54 is still not cured (step S14). FIGS. 7A, 7B, and 7C are sectional views illustrating a process of welding the first panel 51 and the second panel 52. It is noted that FIGS. 7A, 7B, 7C, and 8 illustrate a side view of each of the electrodes 12 and 14.

As illustrated in FIGS. 7A and 7B, welding is performed in the state in which the protrusion 51a of the first panel 51 is inserted in the recess 52a of the second panel 52. In the welding process, the welding-target parts respectively having the protrusion 51a and the recess 52a are held and pressurized by the fixed electrode 12 and the movable electrode 14, and in this state, current is applied between the electrodes 12 and 14. As illustrated in FIG. 8, in the condition in which the work 50 is held and pressurized by the electrodes 12 and 14, the adhesive 54 in the uncured state is pushed aside to the vicinities of the protrusion 51a and the recess 52a. In addition, a top 56 of the protrusion 51a is in contact with a bottom surface of the recess 52a because the height h of the protrusion 51a is greater than the depth d of the recess 52a, as illustrated in FIG. 6. Current is applied between the electrodes 12 and 14 under these conditions, whereby electric conductivity at the welding-target parts of the first panel 51 and the second panel 52 are obtained.

As welding advances, a nugget 58 is produced between the first panel 51 and the second panel 52, as illustrated in FIG. 7C. In addition, the protrusion 51a and the recess 52a are smoothed due to melting of the panels 51 and 52 and pressurizing of the electrodes 12 and 14. As a result, in the work 50 after welding is performed, adverse effects of formation of the protrusion 51a and the recess 52a on appearance and strength are reduced.

After spot welding is performed, the adhesive 54 of the work 50 is cured (step S15). For example, the work 50 is carried from the spot welding apparatus 10 to a heating furnace, which is not illustrated, and the work 50 is then heated in the heating furnace so that the adhesive 54 will be cured. In this manner, the first panel 51 and the second panel 52 are joined together with the adhesive 54 by spot welding.

As described above, the recess 52a, in which the protrusion 51a of the first panel 51 is to be inserted, is formed on the second panel 52. Thus, the spot welding method of this embodiment prevents a gap from occurring between the first panel 51 and the second panel 52 when the first panel 51 and the second panel 52 are caused to overlap on one another. This avoids adverse effect on product accuracy, which may occur in the case of performing welding under existence of a gap. The recess 52a is formed so as to have a depth that allows the protrusion 51a to come into contact with the recess 52a. With this structure, when the first panel 51 and the second panel 52 are held and pressurized by the pair of the electrodes 12 and 14 in welding, the protrusion 51a of the first panel 51 is brought into contact with the recess 52a of the second panel 52. This enables obtaining electric conductivity at the welding-target parts and thereby prevents welding failure from occurring, in the work 50 in which the adhesive 54 in the uncured state is applied between the panels 51 and 52.

In this embodiment, the first panel 51 and the second panel 52, which overlap, are pressed by pushing down the punch 32. Thus, the protrusion 51a and the recess 52a corresponding to the shape of the protrusion 51a are easily formed on the facing surfaces of the first panel 51 and the second panel 52.

In this embodiment, in the state in which the panels 51 and 52 have different thicknesses, pressing is performed so that the recess 52a will be formed on the second panel 52 having a larger thickness. This makes the depth d of the recess 52a less than the height h of the protrusion 51a by using spring-back effect that occurs after pressing. Even in the case in which the first panel 51 and the second panel 52 have the same thickness, the worked area of the second panel 52 is larger than that of the first panel 51, and thus, the amount of spring-back of the second panel 52 is greater than that of the first panel 51.

In this embodiment, the processing mechanism 16 for performing pressing is provided to the spot welding apparatus 10, and the pressure is applied by using the drive mechanism 20 that moves the movable electrode 14, at the time of pressing. This structure can reduce cost of equipment for pressing. In addition, the spot welding apparatus 10 of this embodiment can move the processing mechanism 16 to the non-processing position and perform spot welding on a next work that is set thereto, immediately after pressing is performed. This operation is excellent in production efficiency.

It is noted that the disclosure is not limited to the embodiment and the modified examples described above, and various modifications and alterations may be made without departing from the gist of the disclosure.

In one example, the work 50 to be spot-welded may not be applied with the adhesive 54.

In another example, in the spot welding method, the protrusion 51a of the first panel 51 and the recess 52a of the second panel 52 may not be formed simultaneously, and they may be formed individually by a pressing apparatus other than the spot welding apparatus 10. In this case, the recess 52a is formed so as to have a depth that allows the top of the protrusion 51a to come into contact with the bottom of the recess 52a. In welding, in the state in which the protrusion 51a is inserted in the recess 52a, these welding-target parts are welded by a pair of electrodes.

1. A spot welding method for welding a first panel and a second, panel by applying a current between electrodes in pairs in a state in which the first panel and the second panel overlap one another and are held by the electrodes, the method comprising:
forming a protrusion on a surface facing the second panel, at a welding-target part of the first panel;
forming a recess on a surface facing the protrusion, at a welding-target part, of the second panel, such that the recess has a depth that allows a top of the protrusion to come into contact with a bottom of the recess; and
holding the welding-target part of the first panel and the welding-target part of the second panel between the electrodes, in a state in which the protrusion is inserted in the recess and applying the current between the electrodes.

2. The spot welding method according to claim 1, wherein
the first panel and the second panel are caused to overlap one another and are placed between a male die and a female die such that the second panel is disposed on a side of the female die,
the male die comprises a tapered bar-shaped member,
the female die has a notch into which a tip of the bar-shaped member is to be inserted, and
the protrusion and the recess are formed simultaneously by pushing the bar-shaped member toward the notch.

3. The spot welding method according to claim 1, wherein the second panel has a thickness equal to or greater than a thickness of the first panel.

4. The spot welding method according to claim 2, wherein the second panel has a thickness equal to or greater than a thickness of the first panel.

5. The spot welding method according to claim 2, further comprising:
applying a viscous material between the first panel and the second panel and causing the first panel and the second panel to overlap one another, before forming the protrusion and the recess,
wherein the protrusion and the recess are held by the electrodes and are welded, in a state in which the viscous material is not cured.

6. The spot welding method according to claim 3, further comprising:
applying a viscous material between the first panel and the second panel and causing the first panel and the second panel to overlap one another, before forming the protrusion and the recess,
wherein the protrusion and the recess are held by the electrodes and are welded, in a state in which the viscous material is not cured.

7. The spot welding method according to claim 4, further comprising:
applying a viscous material between the first panel and the second panel and causing the first panel and the second panel to overlap one another, before forming the protrusion and the recess,
wherein the protrusion and the recess are held by the electrodes and are welded, in a state in which the viscous material is not cured.

8. A spot welding apparatus comprising:
a fixed electrode fixed to an apparatus body; and
a movable electrode configured to be brought close to and away from the fixed electrode,
the spot welding apparatus being configured to weld a first panel and a second panel by applying a current between the fixed electrode and the movable electrode in a state in which the first panel and the second panel overlap one another and are held by the fixed electrode and the movable electrode,
the spot welding apparatus further comprising:
a processing mechanism configured to move to a processing position at which the processing mechanism presses the first panel and the second panel and to return from the processing position to a non-processing position,
the processing mechanism comprising:
a tapered bar-shaped member provided in a vicinity of the movable electrode, the bar-shaped member being configured to be moved, by driver configured to move the movable electrode, in a movement direction of the movable electrode at the processing position; and
a die provided in a vicinity of the fixed electrode, the die having a notch corresponding to a shape of a tip of the bar-shaped member, the die being configured to allow the first panel and the second panel to be placed on the die at the processing position.
